(19) United States
(12) Patent Application Publication
(10) Pub. No.: US 2007/0195207 A1
(43) Pub. Date: Aug. 23, 2007

(54) Projection apparatus and method for switching operation modes thereof

(75) Inventor: Sze-Ke Wang, Miao-Li (TW)

Correspondence Address: BACON & THOMAS, PLLC, 625 SLATERS LANE, FOURTH FLOOR, ALEXANDRIA, VA, 22314, US

(73) Assignee: CORETRONIC CORPORATION, Hsinchu (TW)

(21) Appl. No.: 11/650,932

(22) Filed: Jan. 9, 2007

(30) Foreign Application Priority Data
Feb. 9, 2006 (TW) 95104405

(51) Int. Cl. H04N 9/31

(52) U.S. Cl. 348/744

(57) ABSTRACT

A projection apparatus includes a light source module, a first color wheel, a second color wheel and a control unit. The light source module provides an illuminating light beam. The first and the second color wheels are disposed on an optical path of the illuminating light beam. The first and the second color wheels respectively have a first white segment and a second white segment with unequal areas. The control unit is electrically coupled to the first and the second color wheels. In a first mode, the control unit controls the first white segment to stop on the optical path and controls the second color wheel to rotate. In a second mode, the control unit controls the second white segment to stop on the optical path and controls the first color wheel to rotate.

This application claims the benefit of Taiwan application Serial No. 95104405, filed Feb. 9, 2006, the subject matter of which is incorporated herein by reference.

### BACKGROUND OF THE INVENTION

1. Field of the Invention

The invention relates in general to a projection apparatus and a method for switching operation modes thereof, and more particularly to a projection apparatus having at least two operation modes and a method for switching the operation modes thereof.

2. Description of the Related Art

A typical single-piece DLP (Digital Light Processing) projector has a color wheel (CW) for sequentially projecting red (R), green (G) and blue (B) light to a DMD (Digital Micromirror Device) in a time-sharing manner to produce different colors and luminance. However, the R, G and B light are not simultaneously projected onto the DMD such that the luminance cannot be increased. The conventional method is to dispose a white (W) segment in the color wheel to enhance the luminance. However, the mixed color saturation cannot be better than a color wheel composed of only the R, G and B segments. In order to satisfy various requirements of usage, a projector capable of switching operation modes is thus produced.

Referring to FIG. 1A, a conventional DLP projector 10 includes a light source module 1 generating an illumination light beam L, a first color wheel 2, a second color wheel 3, a light integration rod 4, a light valve 5 and a projection lens 6. The first color wheel 2 and the second color wheel 3 as shown in FIG. 1A, for example, respectively have R, G and B segments and R, G, B and W segments. The first color wheel 2 and the second color wheel 3 are disposed in parallel at two sides of a light inlet of the light integration rod 4. The first color wheel 2 is moved to the optical path of the illuminating light beam L along a path M1. The second color wheel 3 is moved to the optical path of the illuminating light beam L along a path M2. The light source module 1 generates the illuminating light beam L. And then the illuminating light beam L passes through the first color wheel 2 or the second color wheel 3, which is moved to the optical path, and the illumination light beam is then collected into the light integration rod 4. Then, the illuminating light beam L after being outputted from the light integration rod 4 is projected onto the light valve 5, and the light valve 5 processes the illuminating light beam L into an image light beam Si, which is finally projected to generate an image on a screen (not shown) through the projection lens 6.

When the projector 10 is set to operate in a data mode, the image displayed by the projector 10 mainly needs the luminance. Thus, the second color wheel 3 having the W segment is moved to the optical path of the illuminating light beam L and is rotated in conjunction with the signal processing to generate a color image by way of projection. When the projector 10 is set to operate in a video mode, the image displayed by the projector 10 mainly needs the saturation of color. So, the first color wheel 2 without the W segment is moved to the optical path of the illuminating light beam L and is rotated in conjunction with the signal processing to generate a color image by way of projection.

In the method for switching operation modes of the projector, however, the projector 10 has to provide the enough space for the first color wheel 2 and the second color wheel 3, thereby enlarging the size of the projector 10. In addition, the color wheel is usually moved by a motor, the provision of the motor increases the risk of projector failure and thus reduces the product reliability, and the motor needs a precise mechanism design to drive the color wheel to a right position. In addition, the supporting element for fixing the color wheel and the provision of the motor also increase the manufacturing cost of the projector.

In addition, as shown in FIG. 1B, another conventional projector 20 utilizes a single dual-layer color wheel 21 having an inner layer A and an outer layer C with different color segments. The color segments of the inner layer A include R, G and B segments, and the color segments of the outer layer C include R, G, B and W segments. The dual-layer color wheel 21 is also disposed at one side of the light inlet of a light integration rod 22. The projector 20 shifts the outer layer C of the dual-layer color wheel 21 or the inner layer A of the dual-layer color wheel 21 to the optical path of the illuminating light beam L provided by a light source module 23 in different display requirements of luminance or color. Then, the illuminating light beam L passes through the color wheel 21 and is outputted from the light integration rod 22 and then projected onto a light valve 25. The light valve 25 transfers the illumination light beam L into an image light beam Si. Finally, a projection lens 26 projects the image light beam Si to display an image on a screen (not shown). However, this method increases the operation load of the motor for moving the color wheel, and reduces the reliability of the color wheel. The motor for moving the color wheel also needs a larger size, so the manufacturing cost of the color wheel is increased. Furthermore, because the color wheel 21 has the dual-layer color segment, the coating cost of the dual-layer color wheel 21 is higher. In addition, the diameter of the dual-layer color wheel 21 is larger, and the size of the projector 20 has to be increased.

### SUMMARY OF THE INVENTION

The invention provides a projection apparatus and a method for switching operation modes of the projection apparatus, wherein at least two color wheels are simultaneously disposed on an optical path of an illuminating light beam so that the requirements of different users are satisfied by switching different operation modes without moving the color wheels.

Besides, The invention provides a projection apparatus and a method for switching operation modes thereof, in which there is no need of extra space for color wheels and motor for moving the color wheels. So, the size and cost of the projection apparatus are reduced.

The invention provides a projection apparatus having a first mode and a second mode and including a light source module, a first color wheel, a second color wheel and a control unit. The light source module provides an illuminating light beam. The first color wheel and the second color wheel are disposed on the optical path of the illuminating light beam. The first color wheel and the second color wheel respectively have a first white segment and a second white segment, and the area of the first white segment is unequal to the area of the second white segment. The control unit is electrically coupled to the first color wheel and the second color wheel. In the first mode, the control unit controls the first white segment to stop on the optical path and controls the second color wheel to rotate. In the second mode, the control unit controls the second white segment to stop on the optical path and controls the first color wheel to rotate.

The invention also achieves the above-identified objects by providing a method for switching operation modes of a projection apparatus. The projection apparatus includes a light source module, a first color wheel and a second color wheel. The light source module provides an illuminating light beam having an optical path. The first color wheel includes a first white segment, the second color wheel includes a second white segment, and an area of the second white segment is unequal to an area of the first white segment. The method includes the steps of: judging the projection apparatus is in a first mode or a second mode; and controlling one of the first color wheel and the second color wheel to rotate, and one of the first white segment and the second white segment to stop on the optical path. When the projection apparatus is in the first mode, the second color wheel rotates and the first white segment is stopped on the optical path to perform an operation of the first mode. When the projection apparatus is in the second mode, the first color wheel rotates and the second white segment is stopped on the optical path to perform an operation of the second mode.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a schematic illustration showing main elements of a conventional DLP projector.

FIG. 1B is a schematic illustration partially showing a structure of a conventional DLP projector using a dual-layer color wheel.

FIG. 2 is a schematic illustration showing main elements of a DLP projector according to a preferred embodiment of the invention.

FIG. 3 is a flow chart showing a method for switching operation modes of the projection apparatus according to the preferred embodiment of the invention.

FIG. 4 is a schematic illustration showing main elements of another DLP projector according to another embodiment of the invention.

FIG. 5 is a schematic illustration showing main elements of still another DLP projector according to still another embodiment of the invention.

FIG. 6 is a schematic illustration showing a color segment arrangement of a color wheel according to the invention.

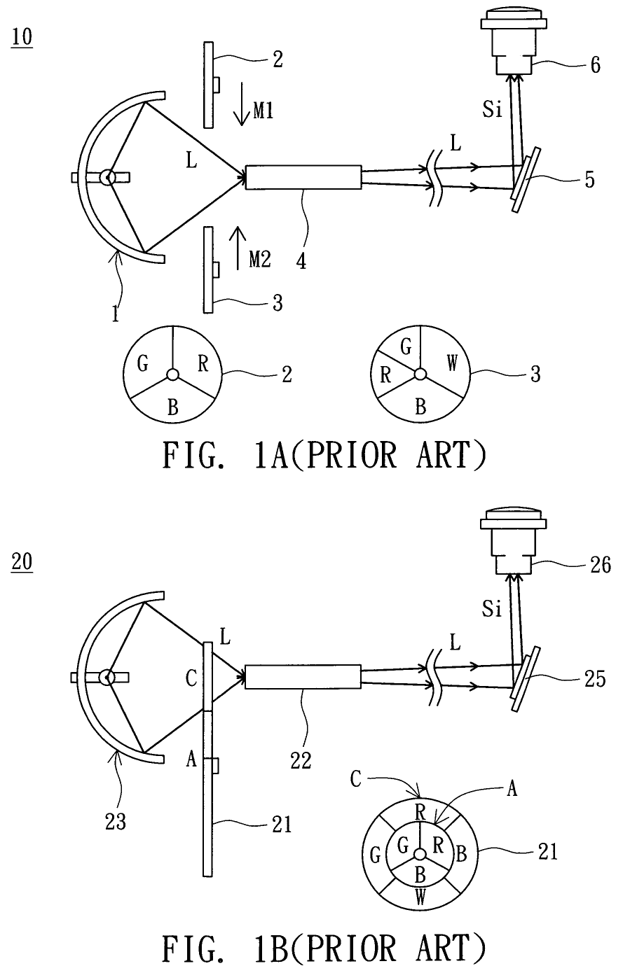

### DETAILED DESCRIPTION OF THE INVENTION

The invention provides a projection apparatus having a first color wheel and a second color wheel both disposed on an optical path between a light source module and a light valve. The first color wheel and the second color wheel respectively have a first white segment and a second white segment having unequal areas. In a first mode, the projection apparatus controls the first color wheel to rotate and to stop the first white segment on the optical path and simultaneously controls the second color wheel to rotate and controls the light valve to generate an image light beam according to an electrical signal outputted from the second color wheel. In a second mode, the projection apparatus controls the second color wheel to rotate and to stop the second white segment on the optical path and simultaneously controls the first color wheel to rotate and controls the light valve to generate an image light beam according to an electrical signal outputted from the first color wheel. Consequently, the projection apparatus does not need any extra space for the color wheels to move, or does not need any additional motor to move the color wheels. Thus, the size and cost of the projection apparatus are reduced effectively. The detailed implementation will be described according to the following preferred embodiment.

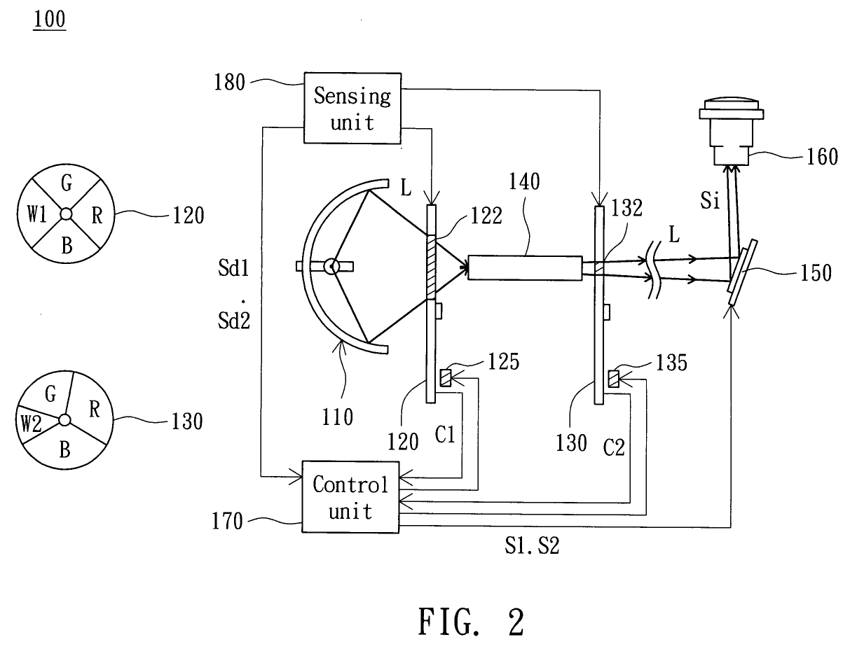

Referring to FIG. 2, a projection apparatus 100 according to a preferred embodiment of the invention includes a light source module 110, a light integration rod 140, a light valve 150, a first color wheel 120, a second color wheel 130, a projection lens 160 and a control unit 170. The light source module 110 provides an illuminating light beam L. The light integration rod 140 is disposed on an optical path of the illuminating light beam L for receiving the illuminating light beam L. The light valve 150 generates an image light beam Si according to the illuminating light beam L outputted from the light integration rod 140, and the image light beam Si is projected onto a screen (not shown) through the projection lens 160 to display an image. The first color wheel 120 and the second color wheel 130 are disposed on the optical path of the illuminating light beam L and are respectively disposed at a light inlet and a light outlet of the light integration rod 140. As shown in FIG. 2, the first color wheel 120 has R, G and B segments and a white segment W1, and the second color wheel 130 has R, G and B segments and a white segment W2, and the area of the white segment W1 is larger than the area of the white segment W2. The control unit 170 is electrically coupled to the first color wheel 120, the second color wheel 130 and the light valve 150. When the projection apparatus 100 operates in a first mode (e.g., a video mode), the control unit 170 controls the white segment W1 of the first color wheel 120 to stop on the optical path of the illuminating light beam L, simultaneously controls the second color wheel 130 to rotate and controls the light valve 150 to generate the image light beam Si according to a second electrical signal S2 outputted from the control unit 170. When the projection apparatus 100 is in a second mode (e.g., a data mode), the control unit 170 controls the white segment W2 of the second color wheel 130 to stop on the optical path of the illuminating light beam L, simultaneously controls the first color wheel 120 to rotate, and controls the light valve 150 to generate the image light beam Si according to a first electrical signal S1 outputted from the control unit 170. In addition, the white segment W1 of the first color wheel 120 and the white segment W2 of the second color wheel 130 can simultaneously stop on the optical path of the illuminating light beam L such that the projection apparatus 100 can be used in a black-and-white image display with the ultra-high luminance.

It is to be noted that the areas of the white segment W1 of the first color wheel 120 and the white segment W2 of the second color wheel 130 are respectively larger than or equal to a first cross section 122 of the illuminating light beam L incident to the first color wheel 120 and a second cross section 132 of the illuminating light beam L incident to the second color wheel 130. In addition, when the projection apparatus 100 operates in the first mode, the control unit 170 controls the white segment W1 of the first color wheel 120 to stop on the optical path of the illuminating light beam L such that the illuminating light beam L passing through the first color wheel 120 completely falls within the white segment W1. When the projection apparatus 100 operates in the second mode, the control unit 170 controls the white segment W2 of the second color wheel 130 to stop on the optical path of the illuminating light beam L such that the illuminating light beam L passing through the second color wheel 130 completely falls within the white segment W2.

In addition, the light source module 110 is, for example, a high-pressure mercury lamp, a white light OLED (Organic Light Emitting Diode), a MHL (Metal Halide Light) or a halogen lamp. The light valve 150 is, for example, a DMD (Digital Micromirror Device), a LCD (Liquid Crystal Display) or a LCOS (Liquid Crystal On Silicon). And, the area of the first white segment W1 is larger than the area of the second white segment W2 according to a preferred embodiment of the invention

In addition, the projection apparatus 100 further includes a sensing unit 180 and braking units 125 and 135. The sensing unit 180, which is coupled to the first color wheel 120, the second color wheel 130 and the control unit 170, senses the rotation angles of the first color wheel 120 and the second color wheel 130 to output a first sensing signal Sd1 and a second sensing signal Sd2 to the control unit 170, respectively. The braking units 125 and 135, which are coupled to the control unit 170, respectively stop the first color wheel 120 and the second color wheel 130. The control unit 170 controls the braking unit 125 or 135 to stop the white segment W1 of the first color wheel 120 or the white segment W2 of the second color wheel 130 on the optical path of the illuminating light beam L according to the first sensing signal Sd1 or the second sensing signal Sd2. In addition, although the invention is illustrated by taking the projection apparatus 100, which has the sensing unit 180 and the braking units 125 and 135 to control the white segments W1 and W2 of the color wheels 120 and 130 to stop on the optical path of the illuminating light beam L as an example, the projection apparatus 100 of the invention may also utilize the sensing unit 180 to sense the rotation angles of the first color wheel 120 and the second color wheel 130 to output the first sensing signal Sd1 and the second sensing signal Sd2, respectively. The first color wheel 120 and the second color wheel 130 output a first control signal C1 and a second control signal C2 to the control unit 170 according to the passed illuminating light beam L. The control unit 170 controls the white segment W1 to stop on the optical path of the illuminating light beam L according to the first control signal C1 and the first sensing signal Sd1. Alternatively, the control unit 170 controls the white segment W2 to stop on the optical path of the illuminating light beam L according to the second control signal C2 and the second sensing signal Sd2. Any implementation is deemed as falling within the scope of the invention as long as the color wheels 120 and 130 are disposed on the optical path of the illuminating light beam L, and the white segment of one of the color wheels is controlled to stop on the optical path of the illuminating light beam L and the other of the color wheels is controlled to rotate to achieve two different conditional effects (data or video mode).

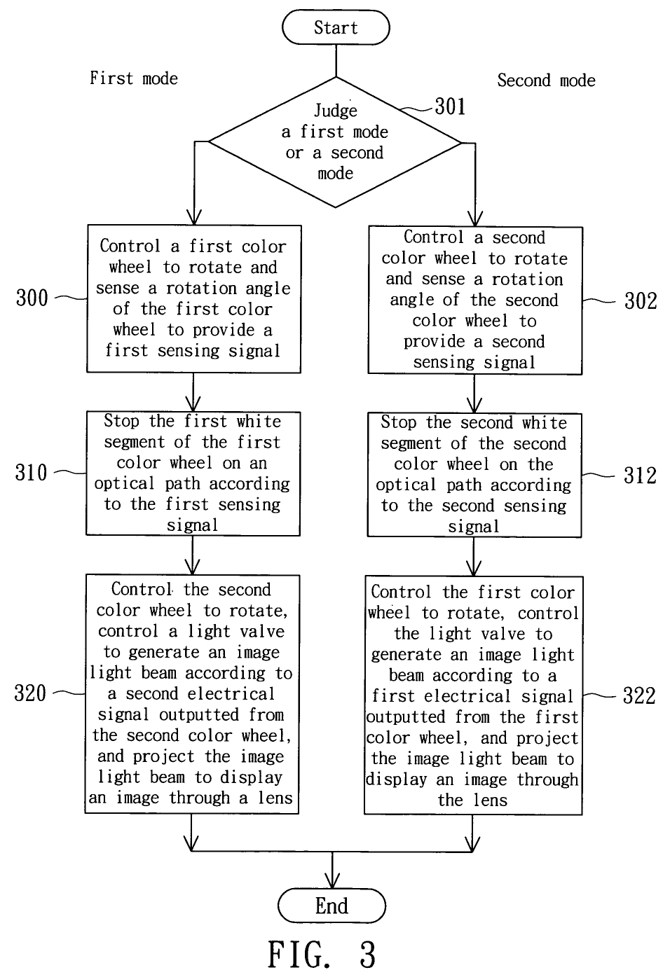

FIG. 3 is a flow chart showing a method for switching operation modes of the projection apparatus according to the preferred embodiment of the invention. As shown in FIG. 3, step 301 judges the projection apparatus 100 is in the first mode or the second mode after the projection apparatus 100 starts operating. This step is implemented when the user selects the required mode. After the control unit 170 receives the selecting instruction of the user, the control unit 170 judges whether the first mode or the second mode has to be entered. Then, the projection apparatus controls one of the first color wheel 120 and the second color wheel 130 to rotate and stops one of the white segment W1 and the white segment W2 on the optical path of the illuminating light beam L. The detailed steps are described in the following. When the control unit 170 judges that the first mode (e.g., the video mode) is operated, steps 300, 310 and 320 are performed. In step 300, the control unit 170 controls the first color wheel 120 to rotate and the sensing unit 180 senses the rotation angle of the first color wheel 120 to output the corresponding first sensing signal Sd1. Next, in step 310, the control unit 170 controls the braking unit 125 according to the first sensing signal Sd1 to stop the white segment W1 of the first color wheel 120 on the optical path of the illuminating light beam L. Finally, in step 320, the control unit 170 controls the second color wheel 130 to rotate, and controls the light valve 150 to generate an image light beam Si to be projected by the projection lens 160 to display an image, according to the second electrical signal S2 outputted from the control unit 170.

When the control unit 170 judges that the second mode (e.g., the data mode) is operated, steps 302, 312 and 322 are performed. In step 302, the control unit 170 controls the second color wheel 130 to rotate and the sensing unit 180 senses the rotation angle of the second color wheel 130 to output the corresponding second sensing signal Sd2. Next, in step 312, the control unit 170 controls the braking unit 135 to stop the white segment W2 of the second color wheel 130 on the optical path of the illuminating light beam L according to the second sensing signal Sd2. Finally, in step 322, the control unit 170 controls the first color wheel 120 to rotate and controls the light valve 150 to generate the image light beam Si, which is projected by the projection lens 160 to display the image, according to the first electrical signal S1 outputted from the control unit 170.

As mentioned hereinabove, the projection apparatus 100 of this embodiment has two color wheels 120 and 130 disposed on the optical path of the illuminating light beam L of the illuminating light beam L, and respectively controls the white segment (W1 or W2) of one of the color wheels (120 or 130) to stop on the optical path of the illuminating light beam L and the other of the color wheels to rotate in order to provide two different scenarios (i.e., operation modes). The two color wheels are fixed on the optical path of the illuminating light beam L of the projection apparatus 100, no extra space for the color wheels 120 and 130 to move has to be provided, and no motor has to be provided to move the color wheels 120 and 130. Thus, the size and cost of the projection apparatus 100 are effectively reduced. In addition, the projection apparatus may have more than two operation modes (e.g., video and data modes) to satisfy the demands of various users.

As mentioned hereinabove, although the invention has the color wheels 120 and 130 respectively disposed at two ends of the light integration rod 140, the color wheels 120 and 130 of the projection apparatus 100 of the invention may also be disposed on the same end of the light integration rod 140, such as the light inlet or light outlet of the light integration rod 140, or even be disposed at any position on the optical path of the illuminating light beam L between the light source module 110 and the light valve 150. Any implementation is deemed as falling within the scope of the invention as long as the color wheels 120 and 130 are disposed on the optical path of the illuminating light beam L, and the white segment of one of the color wheels is controlled to stop on the optical path of the illuminating light beam L and the other of the color wheels is controlled to rotate to achieve two different scenarios (data or video mode).

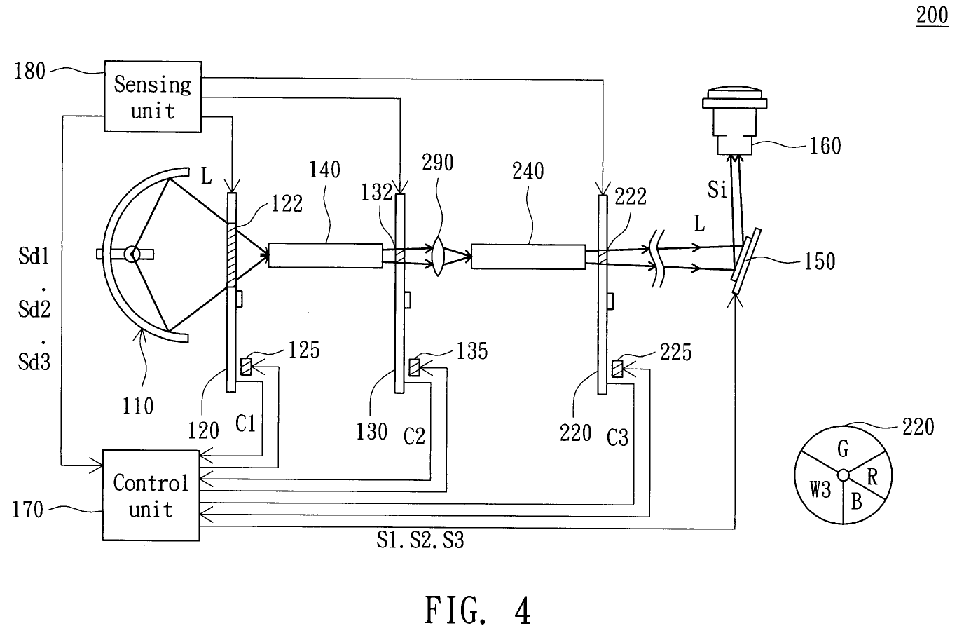

Although the illustrated projection apparatus 100 of the invention includes one light integration rod 140 and two color wheels 120 and 130, a projection apparatus 200 of the invention may also includes two light integration rods 140 and 240 and three color wheels 120, 130 and 220 disposed on the optical path of the illuminating light beam L, as shown in FIG. 4. The first color wheel 120, the second color wheel 130 and the third color wheel 220 are respectively disposed on the light inlet of the light integration rod 140, the light outlet of the light integration rod 140 and the light outlet of the light integration rod 240. The projection apparatus 200 further includes a lens unit 290 disposed between the light integration rod 140 and the light integration rod 240 to converge the illuminating light beam L outputted from the light integration rod 140 into the light inlet of the light integration rod 240. The lens unit 290 is, for example, a relay lens capable of preventing the light loss caused by the divergence of the illuminating light beam L in the light integration rod. The third color wheel 220 includes a white segment W3 having an area unequal to the area of the white segment W1 or W2. In the first mode and the second mode, the control unit 170 controls the white segment W3 of the third color wheel 220 to stop on the optical path of the illuminating light beam L. In the third mode, the control unit 170 controls the white segments W1 and W2 to stop on the optical path of the illuminating light beam L and controls the third color wheel 220 to rotate. Any implementation is deemed as falling within the scope of the invention as long as the color wheels 120, 130 and 220 are disposed on the optical path of the illuminating light beam L, and one of the color wheels is controlled to rotate and the white segments of another two color wheels are controlled to stop on the optical path of the illuminating light beam L to achieve at least two different scenarios (data or video mode).

The projection apparatus according to other preferred embodiment of the invention may further include a fourth color wheel, a fifth color wheel or more color wheels. Increasing the number of color wheels, adjusting the sizes of the R, G, B and white segments of the color wheel, and increasing the numbers of light integration rods and lens units according to the requirement enables the projection apparatus to provide more operation modes for the users to select.

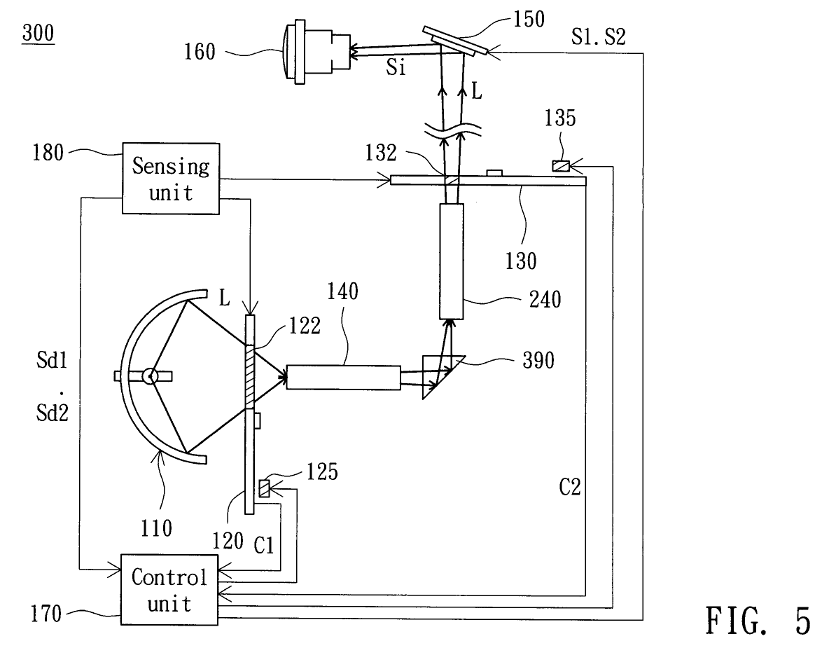

Referring to FIG. 5, a projection apparatus 300 of the invention may also include two light integration rods 140 and 240, one prism 390 and two color wheels 120 and 130 disposed on the optical path of the illuminating light beam L. The optical axis of the light integration rod 140 is perpendicular to that of the light integration rod 240. The prism 390 disposed between the light integration rods 140 and 240 reflects the illuminating light beam L, which is outputted from the light integration rod 140, to the light inlet of the light integration rod 240. The color wheels 120 and 130 are respectively disposed at the light inlet of the light integration rod 140 and the light outlet of the light integration rod 240.

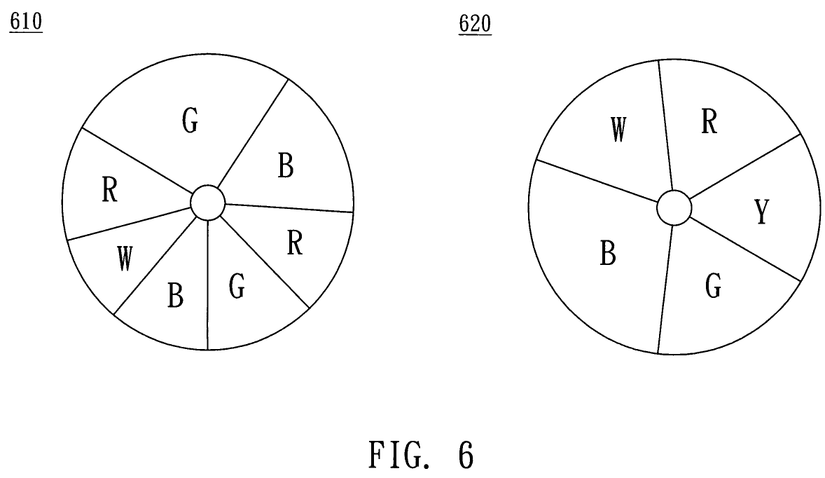

In addition, the sizes of the color segments (R, G, B and white segments) on the color wheel may be varied. As shown in FIG. 6, a color wheel 610 on the left-hand side of FIG. 6 has two sets of R, G and B segments and one white segment W to speed up the color conversion such that the observer's eyes feel more comfortable. In addition to increasing the R, G, B and W segments, preferably, at least one of the yellow (Y), cyan (C) and magenta (M) segments is added to increase the richness of the image color. In a color wheel 620 of FIG. 6, another yellow (Y) segment is added to provide the more precise colors.

In the projection apparatus and the method for switching the operation modes according to the embodiments of the invention, two or more than two color wheels having white segments with different sizes are disposed on the optical path of the illuminating light beam L of the illuminating light beam without moving the color wheel, and only one color wheel rotates and the white segment of the other color wheel stops on the optical path of the illuminating light beam L so that two or more than two operation modes are switched to obtain the best imaging quality. Because no extra space for the color wheels to move has to be provided and no transmitting motor has to be provided to move the color wheels, the size and manufacturing cost of the projection apparatus are effectively decreased and the operating reliability of the projection apparatus are enhanced.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projection apparatus having a first mode and a second mode, the projection apparatus comprising:
a light source module for providing an illuminating light beam;
a first color wheel and a second color wheel disposed on an optical path of the illuminating light beam and respectively having a first white segment and a second white segment, wherein an area of the first white segment is unequal to an area of the second white segment;
a control unit electrically coupled to the first color wheel and the second color wheel, for controlling the first white segment of the first color wheel to stop on the optical path of the illuminating light beam and controlling the second color wheel to rotate when being in the first mode, and for controlling the second white segment of the second color wheel to stop on the optical path of the illuminating light beam and controlling the first color wheel to rotate when being in the second mode;
a light valve electrically coupled to the control unit, for generating an image light beam; and
a projection lens disposed on the optical path of the image light beam for projecting the image light beam to display an image.

2. The projection apparatus according to claim 1, wherein the illuminating light beam passing through the first color wheel and the second color wheel has a first cross section and a second cross section respectively, the areas of the first white segment and the second white segment are larger than or equal to the areas of the first cross section and the second cross section, respectively.

3. The projection apparatus according to claim 1, wherein the first mode is a video mode, the second mode is a data mode, and the area of the first white segment is larger than the area of the second white segment.

4. The projection apparatus according to claim 1, further comprising a light integration rod disposed on the optical path of the illuminating light beam, wherein the first color wheel and the second color wheel are disposed on one end of the light integration rod.

5. The projection apparatus according to claim 1, further comprising a light integration rod disposed on the optical path of the illuminating light beam, wherein the first color wheel and the second color wheel are disposed on two ends of the light integration rod.

6. The projection apparatus according to claim 1, further comprising a third color wheel disposed on the optical path of the illuminating light beam, wherein the third color wheel comprises a third white segment, an area of the third white segment is unequal to the areas of the first white segment and the second white segment, and the control unit controls the third white segment of the third color wheel to stop on the optical path of the illuminating light beam when being in the first mode and the second mode, and the control unit controls the first white segment and the second white segment to stop on the optical path of the illuminating light beam and controls the third color wheel to rotate when being in a third mode.

7. The projection apparatus according to claim 6, further comprising a first light integration rod and a second light integration rod disposed on the optical path of the illuminating light beam, wherein the first color wheel, the second color wheel and the third color wheel are respectively disposed on a light inlet of the first light integration rod, a light outlet of the first light integration rod and a light outlet of the second light integration rod.

8. The projection apparatus according to claim 7, further comprising a lens unit disposed between the first light integration rod and the second light integration rod, for converging the illuminating light beam outputted from the first light integration rod into the second light integration rod.

9. The projection apparatus according to claim 1, further comprising a first light integration rod, a prism and a second light integration rod disposed on the optical path of the illuminating light beam, wherein an optical axis of the first light integration rod is perpendicular to an optical axis of the second light integration rod, the prism is disposed between the first light integration rod and the second light integration rod and reflects the illuminating light beam outputted from the first light integration rod into the second light integration rod, and the first color wheel and the second color wheel are respectively disposed on an inlet of the first light integration rod and an outlet of the second light integration rod.

10. The projection apparatus according to claim 1, wherein the light source module is selected from a group consisting of: a high-pressure mercury lamp, a white light OLED (Organic Light Emitting Diode), a metal halide light (MHL) and a halogen lamp.

11. The projection apparatus according to claim 1, further comprising:
a sensing unit coupled to the control unit, for sensing rotation angles of the first color wheel and the second color wheel and outputting a first sensing signal and a second sensing signal, respectively; and
a braking unit coupled to the control unit, for stopping the first color wheel and the second color wheel,
wherein the control unit controls the braking unit to stop the first white segment of the first color wheel or the second white segment of the second color wheel on the optical path of the illuminating light beam according to the first sensing signal or the second sensing signal.

12. The projection apparatus according to claim 1, further comprising a sensing unit for sensing rotation angles of the first color wheel and the second color wheel and outputting a first sensing signal and a second sensing signal, respectively, wherein the first color wheel and the second color wheel respectively output a first control signal and a second control signal to the control unit according to the passed illuminating light beam, the control unit controls the first white segment to stop on the optical path of the illuminating light beam according to the first control signal and the first sensing signal, and alternatively controls the second white segment to stop on the optical path of the illuminating light beam according to the second control signal and the second sensing signal.

13. The projection apparatus according to claim 1, wherein the light valve is selected from a group consisting of: a DMD (Digital Micromirror Device), a LCD (Liquid Crystal Display) and a LCOS (Liquid Crystal On Silicon).

14. A method for switching operation modes of a projection apparatus, the projection apparatus comprising a light source module, a first color wheel and a second color wheel, the light source module providing an illuminating light beam, the first color wheel comprising a first white segment, the second color wheel comprising a second white segment having an area unequal to an area of the first white segment, the method comprising the steps of:
judging whether the projection apparatus is in a first mode or a second mode; and
controlling one of the first color wheel and the second color wheel to rotate, and the first white segment or the second white segment of the other color wheel to stop on the optical path of the illuminating light beam, when the projection apparatus being in the first mode, the second color wheel rotates and the first white segment being stopped on the optical path of the illuminating light beam to perform an operation of the first mode; and when the projection apparatus being in the second mode, the first color wheel rotates and the second white segment being stopped on the optical path of the illuminating light beam to perform an operation of the second mode.

15. The method according to claim 14, wherein the step of performing the operation of the first mode comprises:
controlling the first color wheel to rotate and sensing a rotation angle of the first color wheel to output a first sensing signal; and
controlling the first white segment of the first color wheel to stop on the optical path of the illuminating light beam according to the first sensing signal.

16. The method according to claim 14, wherein the step of performing the second mode comprises:
controlling the second color wheel to rotate and sensing a rotation angle of the second color wheel to output a second sensing signal; and
controlling the second white segment of the second color wheel to stop on the optical path of the illuminating light beam according to the second sensing signal.
